(19) United States
(12) Patent Application Publication
(10) Pub. No.: US 2011/0136459 A1
(43) Pub. Date: Jun. 9, 2011

(54) APPARATUS AND METHOD FOR SELECTING ANTENNA OF DIVERSITY ANTENNA SYSTEM

(75) Inventor: Sang Hyun MIN, Gyunggi-do (KR)

(73) Assignee: SAMSUNG ELECTRO-MECHANICS CO., LTD., Gyunggi-do (KR)

(21) Appl. No.: 12/852,002

(22) Filed: Aug. 6, 2010

(30) Foreign Application Priority Data
Dec. 3, 2009 (KR) 10-2009-0118902

(51) Int. Cl. H04B 1/06

(52) U.S. Cl. 455/277.2

(57) ABSTRACT

There is provided an apparatus for selecting an antenna of a diversity antenna system that includes an antenna selector selecting one of a first antenna and a second antenna in accordance with an antenna selection signal, a receiver measuring a quality value of a signal from the antenna selected by the antenna selector and determining detection of the signal by comparing whether or not the measured quality value of the signal is higher than a predetermined first reference value, and a selection controller determining an antenna change error by comparing whether or not an antenna stay time when the signal is continuously detected is within a predetermined error available time when the signal is detected in the receiver and controls the changing of the antenna to a previous antenna when the antenna stay time is within the error available time.

### CROSS-REFERENCE TO RELATED APPLICATIONS

This application claims the priority of Korean Patent Application No. 10-2009-0118902 filed on Dec. 3, 2009, in the Korean Intellectual Property Office, the disclosure of which is incorporated herein by reference.

### BACKGROUND OF THE INVENTION

1. Field of the Invention

The present invention relates to an apparatus and a method for selecting an antenna of a diversity antenna system that can be adopted in wireless communication systems such as a DSSS (Direct Sequence Spread Spectrum), etc., and more particularly, to an antenna and a method for selecting an antenna of a diversity antenna system that are capable of preventing an antenna selection error and reducing the loss of a data signal.

2. Description of the Related Art

In general, there is greater difficulty in ensuring signal quality in wireless communications than in wired communications and in particular, since wireless communications are vulnerable to multi-path loss, in wireless communications, multi-path signal loss must be compensated. As a method for compensating multipath signal loss, antenna diversity technology using a plurality of antennas has been developed and used for various wireless communication technologies.

The antenna diversity generally includes a scheme of combining and using all signals of the plurality of antennas and a scheme of selecting one antenna having the largest signal intensity among the plurality of antennas.

Meanwhile, among wireless communication systems, since a DSSS-based packet communication system has an advantage of detecting a signal even when noise or an external signal has a large magnitude by using spreading and despreading properties of the signal, a scheme of detecting the introduction of the signal by observing a typical signal correlation result is primarily used in order to utilize the advantage of this scheme.

In the antenna diversity system adopted among known wireless communication systems, since a scheme of calculating a received signal strength indication (RSSI) after a sufficient time elapses by actuating an AGC at the time of performing suitability testing for an antenna other than a start antenna after detecting a packet signal is time consuming, the antenna selection scheme indirectly selects an antenna having the largest received signal strength indication (RSSI) by calculating a digital power value for a short time and comparing the AGC gain value with the digital power value after the received signal strength indication is fixed to an AGC gain value of a predetermined initial antenna without actuating the AGC.

In the known diversity antenna system, the antenna selection scheme is a scheme capable of finding the most suitable antenna during the short time after the signal is normally detected in advance.

However, in the known diversity antenna system, an operation of searching for an optimal antenna and an operation of detecting the signal in a modem have a close influence on each other and as a result, when the diversity antenna system is applied to a preamble-based packet communication system which detects a packet by using a correlation characteristic, the following problems occur.

First, an incorrect antenna may be selected due to asynchronization between a signal detecting timing and an antenna changing time and a detailed description thereof will be given with reference to FIGS. 1 and 2.

FIG. 1 is a diagram describing a first problem at the time of selecting an antenna in a known diversity antenna system. Referring to FIG. 1, a preamble symbol is lost due to asynchronization between the signal detecting timing and the antenna changing time.

That is, a plurality of preamble symbols are lost due to asynchronization between the signal detecting timing and the antenna changing time, such that a packet detecting timing is delayed and an antenna searching timing is delayed, thereby substantially reducing the number of preambles to be subsequently available for use in a modem.

For example, in the case where a first antenna ANT1 has sufficient reception power, such that a received signal strength indication Pd is larger than a first reference value Pref1 and the signal is detected, and a second antenna ANT2 has very low reception power, such that the received signal strength indication Pd is lower than the first reference value Pref1 and the signal is not detected, when data begins to be introduced during the latter part of a section of the first antenna ANT1 and the data is handed over to the second antenna ANT2 approximately after a middle point of a first data packet data1, the received signal strength indication of the first antenna ANT1 is high, while the received signal strength indication of the second antenna ANT2 is low. Therefore, when both the received signal strength indications are combined, the received signal strength indication is smaller than the first reference value, such that detection of the first data packet fails.

As a result, a received signal strength indication is thereafter reduced during a section of the second antenna ANT2, such that the signal cannot be detected. Therefore, preamble data is lost and thereafter, the antenna is again changed to the first antenna ANT1 to detect the signal by using a fourth data packet data 4. In this case, the majority of preamble data packets are lost, such that a problem occurs in testing, estimating, and demodulating the signal in the modem afterwards.

FIG. 2 is a diagram describing a second problem at the time of selecting an antenna in a known diversity antenna system. The problem shown in FIG. 2 corresponds to a problem in determination of an incorrect antenna due to the occurrence of a synchronization problem.

That is, the packet data begin to be introduced during the latter part of the time in which the first antenna ANT1 is selected; however, an antenna changing time is up, such that just after the antenna is changed to the second antenna ANT2, a packet detection signal is generated and thus, it is incorrectly judged that the signal has been detected by the second antenna ANT2 and since an automatic gain control (AGC) operation is not normally completed at the time when the packet detection signal is generated, a received signal strength indication (RSSI), measured by an operation of the automatic gain control (AGC) is also measured to be larger than the actual received signal strength indication of the second antenna ANT2, which is larger than that of the first reference value. Therefore, the current antenna is selected as the final antenna without delay, such that an error in which a signal inputted through the selected antenna is demodulated.

### SUMMARY OF THE INVENTION

An aspect of the present invention provides an apparatus and a method for selecting an antenna of a diversity antenna system that are capable of preventing an antenna selection error and reducing the loss of a data signal.

According to an aspect of the present invention, there is provided an apparatus for selecting an antenna of a diversity antenna system that includes an antenna selector selecting one of a first antenna and a second antenna in accordance with an antenna selection signal, a receiver measuring a quality value of a signal from the antenna selected by the antenna selector and determining the detection of the signal by comparing whether or not the measured quality value of the signal is higher than a predetermined first reference value, and a selection controller determining an antenna change error by comparing whether or not an antenna stay time when the signal is continuously detected is within a predetermined error available time when the signal is detected in the receiver and controls the change of the antenna to a previous antenna when the antenna stay time is within the error available time.

The quality value of the signal is set to at least one value of a correlation value of the signal, the intensity of the signal, and the power of the signal.

The receiver determines whether or not the quality value of the signal is higher than a second reference value set to be lower than the first reference value when the signal is not detected up to a predetermined antenna changing time and controls the change of the antenna when the quality value of the signal is lower than the second reference value.

The selection controller controls a waiting operation until the antenna stay time exceeds a predetermined no-error time when the antenna stay time is within the error available time.

The receiver selects a current antenna as a reception antenna when the measured quality value of the signal is higher than a third reference value set to be higher than the first reference value and selects a final reception antenna by controlling the change of the antenna and performing the signal quality measurement process again when the measured quality value of the signal is not higher than a third reference value set to be higher than the first reference value.

According to another aspect of the present invention, there is provided a method for selecting an antenna of a diversity antenna system that includes: a first signal detecting operation of determining the detection of a signal by comparing whether or not a signal quality value of a signal from a selected antenna is higher than a predetermined first reference value; a change error determining operation of detecting an antenna stay time when the signal is continuously detected and determining whether or not the antenna stay time is within a predetermined error available time when the signal is detected during the first signal detecting operation; and an antenna rechanging operation of changing a current antenna to a previous antenna when the antenna stay time is within the error available time during the change error determining operation.

According to another aspect of the present invention, the method for selecting an antenna of a diversity antenna system further includes: a second signal detecting operation of determining whether or not the quality value of the signal is higher than a second reference value set to be lower than the first reference value when the signal is not detected up to a predetermined antenna changing time during the first signal detecting operation; and an antenna changing operation of changing the antenna when the quality value of the signal is lower than the second reference value during the second signal detecting operation.

According to another aspect of the present invention, there is provided a method for selecting an antenna of a diversity antenna system that includes: a first signal detecting operation of determining the detection of a signal by comparing whether or not a signal quality value of a signal from a selected antenna is higher than a predetermined first reference value; a second signal detecting operation of determining whether or not the quality value of the signal is higher than a second reference value set to be lower than the first reference value when the signal is not detected up to a predetermined antenna changing time during the first signal detecting operation; and an antenna changing operation of changing the antenna when the quality value of the signal is lower than the second reference value during the second signal detecting operation.

According to another aspect of the present invention, the method for selecting an antenna of a diversity antenna system further includes: a change error determining operation of detecting an antenna stay time when the signal is continuously detected and determining whether or not the antenna stay time is within a predetermined error available time when the signal is detected during the first signal detecting operation; and an antenna rechanging operation of changing a current antenna to a previous antenna when the antenna stay time is within the error available time during the change error determining operation.

According to another aspect of the present invention, there is provided a method for selecting an antenna of a diversity antenna system that includes: a first signal detecting operation of determining the detection of a signal by comparing whether or not a signal quality value of a signal from a selected antenna is higher than a predetermined first reference value; a second signal detecting operation of determining whether or not the quality value of the signal is higher than a second reference value set to be lower than the first reference value when the signal is not detected up to a predetermined antenna changing time during the first signal detecting operation; an antenna changing operation of changing the antenna when the quality value of the signal is lower than the second reference value during the second signal detecting operation; a change error determining operation of detecting an antenna stay time when the signal is continuously detected and determining whether or not the antenna stay time is within a predetermined error available time when the signal is detected during the first signal detecting operation; an antenna rechanging operation of changing a current antenna to a previous antenna when the antenna stay time is within the error available time during the change error determining operation; and a waiting operation of waiting until the antenna stay time exceeds a predetermined no-error time when the antenna stay time is within the error available time during the change error determining operation.

According to another aspect of the present invention, the quality value of the signal is set to be at least one value of a correlation value of the signal, the intensity of the signal, and the power of the signal.

Further, the method for selecting an antenna of a diversity antenna system further includes a signal quality comparing/final antenna selecting operation of, after the antenna rechanging operation, measuring a signal quality value for the selected antenna, selecting a current antenna as a reception antenna when the measured quality value of the signal is higher than a third reference value set to be higher than the first reference value and selecting a final reception antenna by controlling the change of the antenna and performing the signal quality measurement process again when the measured quality value of the signal is not higher than a third reference value set to be higher than the first reference value.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram describing a first problem at the time of selecting an antenna in a known diversity antenna system;

FIG. 2 is a diagram describing a second problem at the time of selecting an antenna in a known diversity antenna system;

FIG. 3 is a block diagram of an apparatus for selecting an antenna of a diversity antenna system according to an embodiment of the present invention;

FIG. 4 is a flowchart of a method for selecting an antenna of a diversity antenna system according to an embodiment of the present invention;

FIG. 5 is a diagram describing the relationship of a signal quality value Pd, a first reference value Pref1, and a change reference value Pref2 according to an embodiment of the present invention;

FIG. 6 is a diagram describing the relationship of an antenna changing time To, an error available time Teo, a no-error time Tex, and an antenna stay time Tc according to an embodiment of the present invention; and

FIG. 7 is a diagram describing improvements 1 and 2 according to an embodiment of the present invention.

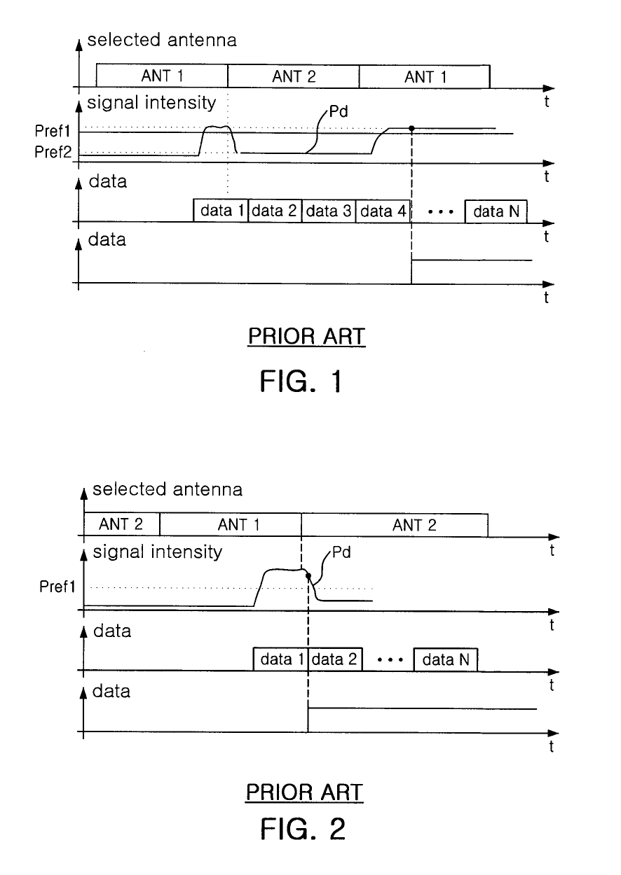

### DETAILED DESCRIPTION OF THE PREFERRED EMBODIMENT

Exemplary embodiments of the present invention will now be described in detail with reference to the accompanying drawings.

The present invention is not limited to the exemplary embodiments and the exemplary embodiments are used to help in understanding the spirit of the present invention. Like reference numerals refer to like elements in the accompanying drawings.

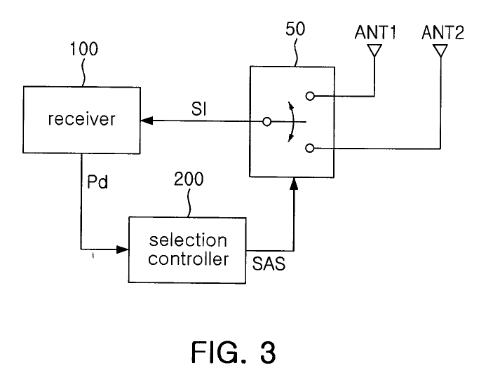

FIG. 3 is a block diagram of an apparatus for selecting an antenna of a diversity antenna system according to an embodiment of the present invention.

Referring to FIG. 3, the apparatus for selecting the antenna of the diversity antenna system according to the embodiment of the present invention includes an antenna selector 50 selecting one antenna in accordance with an antenna selection signal (SAS) from a first antenna ANT1 and a second antenna ANT2, a receiver 100 measuring a quality value Pd of a signal SI from the antenna selected by the antenna selector 50 and determining the detection of the signal by comparing whether or not the measured quality value of the signal is larger than a predetermined first reference value, and a selection controller 200 determining an antenna change error by comparing whether or not an antenna stay time Tc when the signal is continuously detected is within a predetermined error available time Teo when the signal is detected in the receiver 100 and when the antenna stay time Tc is within the error available time Teo, controlling the change to the previous antenna.

Herein, the quality value of the signal may be set to at least one value of a correlation value of the signal, the intensity of the signal, and the power of the signal.

The selection controller 200 determines whether or not the signal quality value Pd is higher than a second reference value Pref2 that is set to be lower than the first reference value Pref1 when the signal is not detected up to the predetermined antenna changing time and controls the change of the antenna when the signal quality value Pd is lower than the second reference value Pref2.

The selection controller 200 controls a waiting operation until the antenna stay time Tc exceeds a predetermined no-error time Tex when the antenna stay time Tc is not within the error available time Teo.

The receiver 100 selects a current antenna as a reception antenna when the measured signal quality value is higher than a third reference value that is set to be higher than the first reference value and performs a signal quality measurement process again by controlling the change of the antenna and controls selection of a final reception antenna when the measured signal quality value is not higher than a third reference value that is set to be higher than the first reference value.

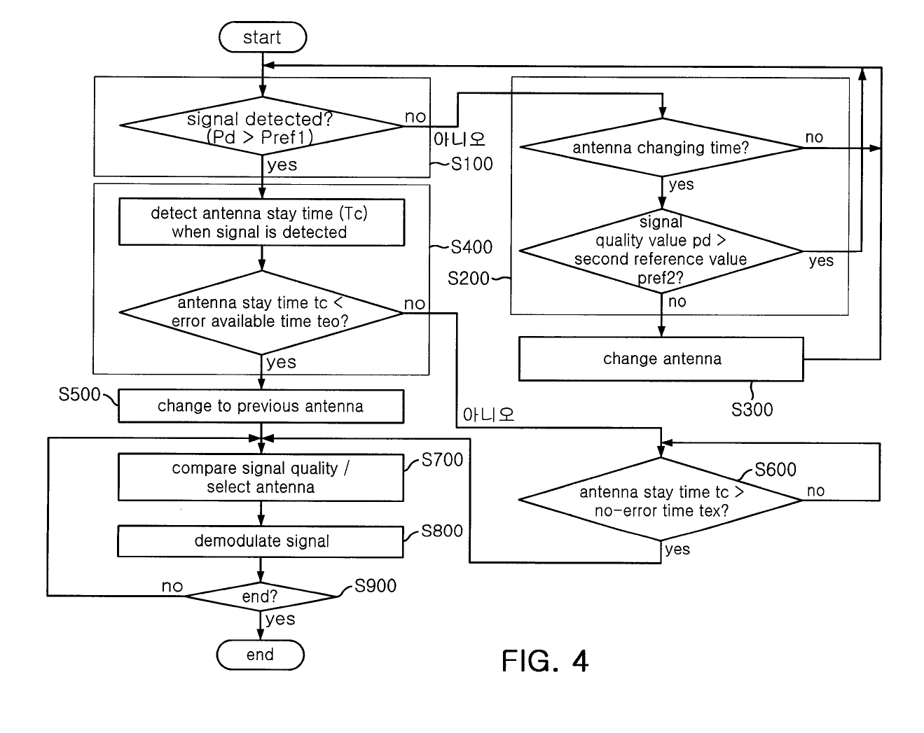

FIG. 4 is a flowchart of a method for selecting an antenna of a diversity antenna system according to an embodiment of the present invention.

Referring to FIG. 4, the method may include a first signal detecting operation (S100) of determining whether or not the signal is detected by comparing whether or not the signal quality value Pd of the signal from the selected antenna is higher than a predetermined first reference value Pref1, a second signal detecting operation (S200) of determining whether or not the signal quality value Pd is higher than the second reference value Pref2 set to be lower than the first reference value Pref1 when the signal is not detected up to the predetermined antenna changing time during the first signal detecting operation (S100), an antenna changing operation (S300) of changing the antenna when the signal quality value Pd is lower than the second reference value Pref2 during the second signal detecting operation (S200), a change error determining operation (S400) of detecting an antenna stay time Tc when the signal is continuously detected and determining the antenna stay time Tc is within a predetermined error available time Teo when the signal is detected during the first signal detecting operation (S100), an antenna rechanging operation (S500) of changing the antenna to a previous antenna when the antenna stay time Tc is within the error available time during the change error determining operation (S300), and a waiting operation (S600) of waiting until the antenna stay time Tc exceeds a predetermined no-error time Tex when the antenna stay time Tc is within the error available time Teo during the change error determining operation (S300).

Herein, the quality value of the signal may be set to at least one value of a correlation value of the signal, the intensity of the signal, and the power of the signal.

Further, referring to FIG. 4, the method according to the embodiment of the present invention may further include a signal quality comparing/antenna final selecting operation (S700) of measuring the signal quality value for the selected antenna after the antenna rechanging operation, selecting the current antenna as the reception antenna when the measured signal quality value is higher than a third reference value that is set to be higher than the first reference value, or selecting a final reception antenna by performing a signal quality measurement process again through controlling the change of the antenna.

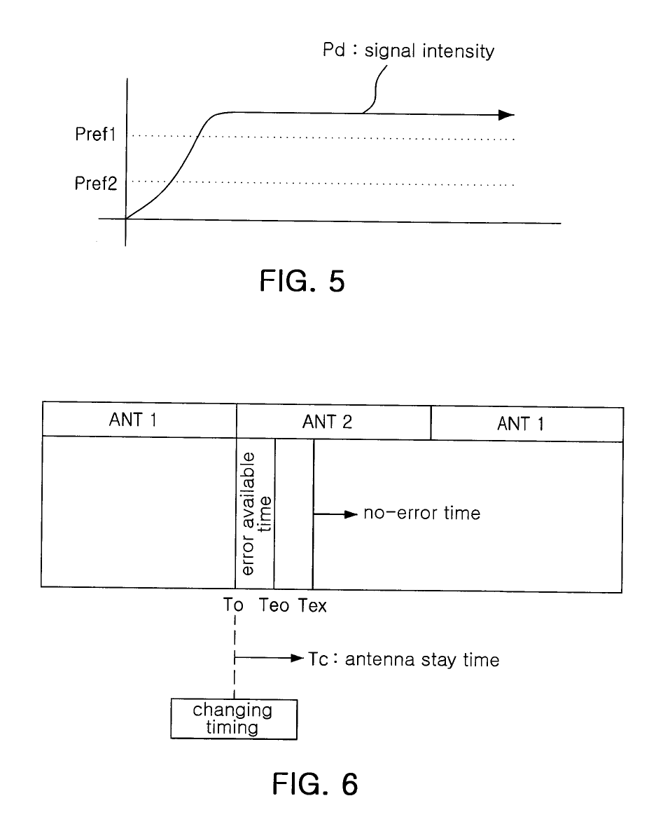

FIG. 5 is a diagram describing the relationship of a signal quality value Pd, a first reference value Pref1, and a change reference value Pref2 according to an embodiment of the present invention. The signal quality value Pd when the signal is normally received is higher than the predetermined first reference value Pref1 and the predetermined second reference value Pref2.

Further, the first reference value Pref1 as a reference value for detecting whether or not the signal is normally received is higher than the second reference value Pref2. The second reference value Pref2 is a sub-reference value for determining whether or not the signal quality value is lower than the signal quality value received when the signal is normally received, but is low enough to change the antenna.

FIG. 6 is a diagram describing the relationship of an antenna changing time To, an error available time Teo, a no-error time Tex, and an antenna stay time Tc according to an embodiment of the present invention. In FIG. 6, To represents the antenna changing time, Teo as a time up to a predetermined time from the antenna changing time represents the error available time when the incorrect antenna change may occur within the period of the signal detection time. Tex, as a time set to be longer than the error available time Teo at the antenna changing time, represents a time for ensuring that there is no error in changing the antenna after the antenna changing time.

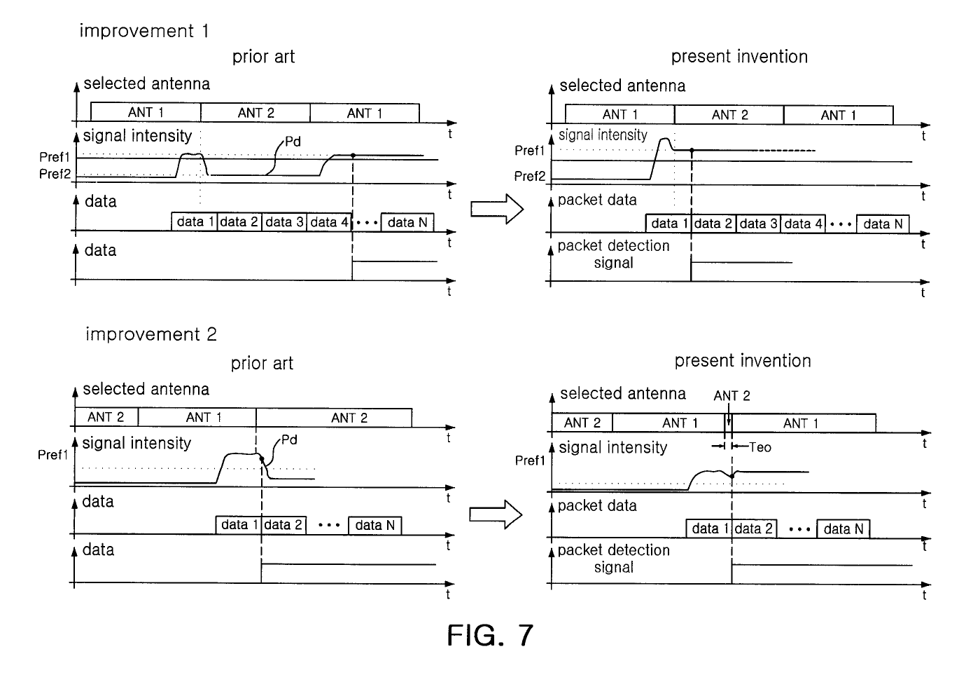

FIG. 7 is a diagram describing improvements 1 and 2 according to an embodiment of the present invention. In FIG. 7, improvement 1 shows that a known problem in which a data signal is lost due to incorrect antenna selection can be improved. Improvement 2 shows that a problem in incorrect antenna selection can be improved.

Hereinafter, the operation and effect of the present invention will be described in detail with reference to the accompanying drawings.

When the apparatus for selecting the antenna of the diversity antenna system according to the embodiment of the present invention is described with reference to FIG. 3, referring to FIG. 3, in the apparatus for selecting the antenna in the diversity antenna system according to the embodiment of the present invention, an antenna selector 50 according to the embodiment of the present invention selects one antenna of the first antenna ANT1 and the second antenna ANT2 in accordance with an antenna selection signal (SAS) and transmits the signal through the selected antenna to the receiver 100.

The receiver 100 measures the quality value Pd of the signal SI from the antenna selected by the antenna selector 50 and determines the detection of the signal by comparing whether or not the measured signal quality value Pd is higher than the predetermined first reference value Pref1.

Herein, the quality value of the signal may be set to be at least one of a correlation value of the signal, the intensity of the signal, and the power of the signal.

For example, when the correlation value and the intensity are set as the quality value of the signal, in the case where the measured correlation value is larger than a reference correlation value and the measurement signal intensity is larger than a reference intensity, it is determined that the signal has been detected.

When the signal is detected in the receiver 100, the selection controller 200 determines an antenna change error by comparing whether or not the antenna stay time Tc when the signal is continuously detected is within the predetermined error available time Teo and when the antenna stay time Tc is within the error available time Teo, controls the changing of the antenna to a previous antenna.

As a result, the antenna selector 50 changes the currently selected antenna to another antenna in accordance with the control of the selection controller 200.

Further, the selection controller 200 determines whether or not the signal quality value Pd is higher than a second reference value Pref2 which is set to be lower than the first reference value Pref1 when the signal is not detected up to the predetermined antenna changing time and controls the change of the antenna when the signal quality value Pd is lower than the second reference value Pref2.

As a result, the antenna selector 50 changes the currently selected antenna to another antenna in accordance with the control of the selection controller 200.

In addition, the selection controller 200 controls a waiting operation until the antenna stay time Tc exceeds a predetermined no-error time Tex when the antenna stay time Tc is not within the error available time Teo.

Therefore, the receiver 100 according to the embodiment of the present invention performs a process of demodulating the signal by selecting an appropriate antenna after the antenna is changed to the previous antenna or when a waiting operation control is terminated while waiting for processing the signal in accordance with the waiting operation control from the selection controller 200.

That is, the receiver 100 measures the signal quality value for the currently selected antenna, selects the current antenna as the reception antenna when the measured signal quality value is higher than the third reference value set to be higher than the first reference value and selects the final reception antenna by controlling the change of the antenna and performing the signal quality measurement process again when the measured signal quality value is not higher than the third reference value set to be higher than the first reference value. Thereafter, the receiver 100 demodulates a signal received through a final antenna.

Hereinafter, a method for selecting an antenna of a diversity antenna system according to an embodiment of the present invention will be described with reference to FIG. 4.

Referring to FIG. 4, in the method for selecting an antenna of a diversity antenna system, first, during the first signal detecting operation (S100), it is determined whether or not the signal is detected by comparing whether or not the signal quality value Pd of the signal from the selected antenna is higher than the predetermined first reference value Pref1.

Herein, the quality value of the signal may be set to at least one value of a correlation value of the signal, the intensity of the signal, and the power of the signal.

For example, when the correlation value and the intensity are set as the quality value of the signal, in the case where the measured correlation value is larger than a reference correlation value and the measurement signal intensity is larger than a reference intensity, it is determined that the signal is detected.

Next, during the second signal detecting operation (S200), it is determined whether or not the signal quality value Pd is higher than the second reference value Pref2 to be set to be lower than the first reference value Pref1 when the signal is not detected up to a predetermined antenna changing time during the first signal detecting operation (S100).

Referring to FIG. 5, the first reference value Pref1 as a reference value for detecting whether or not the signal is normally received is higher than the second reference value Pref2. The second reference value Pref2 is a sub-reference value for determining whether or not the signal quality value is lower than the signal quality value received when the signal is normally received, but is low enough to change the antenna.

Next, during the antenna changing operation (S300), the antenna is changed when the signal quality value Pd is lower than the second reference value Pref 2 during the second signal detecting operation (S200), while the antenna is not changed; however, the current antenna only is used when the signal quality value Pd is not lower than the second reference value Pref2.

Through the operation process, the known problem shown in improvement 1 of FIG. 7 can be improved. That is, it is possible to prevent the loss of the data signal that occurs due to the wrong antenna selection in advance.

Next, during the change error determining operation (S400), when the signal is detected during the first signal detecting operation (S100), the antenna stay time Tc when the signal is continuously detected is detected and it is determined whether or not the antenna stay time Tc is within the predetermined error available time Teo.

Referring to FIG. 6, To represents the antenna changing time, Teo as a time up to a predetermined time from the antenna changing time represents the error available time when the incorrect antenna change may occur in the signal detection within the time. Tex represents a time for determining the no-error time after the error available time Teo and it can be ensured that the selection error of the antenna is unavailable after the no-error time Tex.

In addition, during the antenna rechanging operation (S500), the antenna is changed to the previous antenna when the antenna stay time Tc is within the error available time Teo during the change error determining operation (S300).

Through the operational process, the known problem shown in improvement 2 of FIG. 7 can be improved. That is, a problem in which it is impossible to restore the signal due to incorrect antenna selection can be improved.

Meanwhile, during the waiting operation (S600), the waiting period is continued until the antenna stay time Tc exceeds the predetermined no-error time Tex when the antenna stay time Tc is within the error available time Teo during the change error determining operation S300.

In addition, during the signal quality comparing/antenna final selection operation (S700), after the antenna rechanging operation (S500) or the waiting operation (S600), the signal quality value for the selected antenna is measured and when the measured signal quality value is higher than the third reference value set to be higher than the first reference value, the current antenna is selected as the reception antenna and when the measured signal quality value is higher than the third reference value set to be higher than the first reference value, the final reception antenna is selected by controlling the change of the antenna and performing the signal quality measurement process again.

The signal received through the selected final antenna is repetitively demodulated before the termination (S800 and S900).

According to the embodiment of the present invention, it is advantageous as follows.

That is, in the known scheme, the signal quality may be deteriorated or the signal may be impossible to receive due to incorrect antenna selection, but in the present invention, it is possible to improve reception performance by remarkably decreasing the probability of selecting the incorrect antenna by improving the problem.

Next, in the prior art, the antenna is changed to an antenna having inferior reception performance while an antenna having superior reception performance receives packet data, such that a plurality of preambles are lost and thereafter, data is not normally demodulated in a demodulator; however, according to the embodiment of the present invention, it is possible to improve the reception performance by shortening a packet detection time and a searching time of an optimal antenna through solving the above-mentioned problems.

As set forth above, according to exemplary embodiments of the invention, in a diversity antenna system, it is possible to prevent an antenna selection error and reducing the loss of a data signal.

Specifically, it is possible to prevent signal quality from being deteriorated due to an incorrect antenna selection and preclude a case in which reception is impossible and as a result, improve reception performance.

Further, in the prior art, the antenna is changed to an antenna having inferior reception performance while an antenna having superior reception performance receives packet data, such that a plurality of preambles are lost and thereafter, data is not normally demodulated in a demodulator, but according to the embodiment of the present invention, it is possible to improve the reception performance by shortening a packet detection time and a searching time of an optimal antenna through solving the above-mentioned problems.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for selecting an antenna of a diversity antenna system, comprising:
an antenna selector selecting one of a first antenna and a second antenna in accordance with an antenna selection signal;
a receiver measuring a quality value of a signal from the antenna selected by the antenna selector and determining the detection of the signal by comparing whether or not the measured quality value of the signal is higher than a predetermined first reference value; and
a selection controller determining an antenna change error by comparing whether or not an antenna stay time when the signal is continuously detected is within a predetermined error available time when the signal is detected in the receiver and controls the change of the antenna to a previous antenna when the antenna stay time is within the error available time.

2. The apparatus for selecting an antenna of a diversity antenna system of claim 1, wherein the quality value of the signal is set to at least one value of a correlation value of the signal, the intensity of the signal, and the power of the signal.

3. The apparatus for selecting an antenna of a diversity antenna system of claim 1, wherein the receiver determines whether or not the quality value of the signal is higher than a second reference value set to be lower than the first reference value when the signal is not detected up to a predetermined antenna changing time and controls the change of the antenna when the quality value of the signal is lower than the second reference value.

4. The apparatus for selecting an antenna of a diversity antenna system of claim 3, wherein the selection controller controls awaiting operation until the antenna stay time exceeds a predetermined no-error time when the antenna stay time is not within the error available time.

5. The apparatus for selecting an antenna of a diversity antenna system of claim 4, wherein the receiver selects a current antenna as a reception antenna when the measured quality value of the signal is higher than a third reference value set to be higher than the first reference value and selects a final reception antenna by controlling the change of the antenna and performing the signal quality measurement process again when the measured quality value of the signal is not higher than a third reference value set to be higher than the first reference value.

6. A method for selecting an antenna of a diversity antenna system, comprising:
a first signal detecting operation of determining the detection of a signal by comparing whether or not a signal quality value of a signal from a selected antenna is higher than a predetermined first reference value;
a change error determining operation of detecting an antenna stay time when the signal is continuously detected and determining whether or not the antenna stay time is within a predetermined error available time when the signal is detected during the first signal detecting operation; and
an antenna rechanging operation of changing a current antenna to a previous antenna when the antenna stay time is within the error available time during the change error determining operation.

7. The method for selecting an antenna of a diversity antenna system of claim 5, wherein the quality value of the signal is set to at least one value of a correlation value of the signal, the intensity of the signal, and the power of the signal.

8. The method for selecting an antenna of a diversity antenna system of claim 6, further comprising:
a second signal detecting operation of determining whether or not the quality value of the signal is higher than a second reference value set to be lower than the first reference value when the signal is not detected up to a predetermined antenna changing time during the first signal detecting operation; and
an antenna changing operation of changing the antenna when the quality value of the signal is lower than the second reference value during the second signal detecting operation.

9. The method for selecting an antenna of a diversity antenna system of claim 8, further comprising a signal quality comparing/final antenna selecting operation of, after the antenna rechanging operation, measuring a signal quality value for the selected antenna, selecting a current antenna as a reception antenna when the measured quality value of the signal is higher than a third reference value set to be higher than the first reference value and selecting a final reception antenna by controlling the change of the antenna and performing the signal quality measurement process again when the measured quality value of the signal is not higher than a third reference value set to be higher than the first reference value.

10. A method for selecting an antenna of a diversity antenna system, comprising:
a first signal detecting operation of determining the detection of a signal by comparing whether or not a signal quality value of a signal from a selected antenna is higher than a predetermined first reference value;
a second signal detecting operation of determining whether or not the quality value of the signal is higher than a second reference value set to be lower than the first reference value when the signal is not detected up to a predetermined antenna changing time during the first signal detecting operation; and
an antenna changing operation of changing the antenna when the quality value of the signal is lower than the second reference value during the second signal detecting operation.

11. The method for selecting an antenna of a diversity antenna system of claim 10, wherein the quality value of the signal is set to at least one value of a correlation value of the signal, the intensity of the signal, and the power of the signal.

12. The method for selecting an antenna of a diversity antenna system of claim 10, further comprising:
a change error determining operation of detecting an antenna stay time when the signal is continuously detected and determining whether or not the antenna stay time is within a predetermined error available time when the signal is detected during the first signal detecting operation; and
an antenna rechanging operation of changing a current antenna to a previous antenna when the antenna stay time is within the error available time during the change error determining operation.

13. The method for selecting an antenna of a diversity antenna system of claim 12, further comprising a signal quality comparing/final antenna selecting operation of, after the antenna rechanging operation, measuring a signal quality value for the selected antenna, selecting a current antenna as a reception antenna when the measured quality value of the signal is higher than a third reference value set to be higher than the first reference value and selecting a final reception antenna by controlling the change of the antenna and performing the signal quality measurement process again when the measured quality value of the signal is higher than a third reference value set to be higher than the first reference value.

14. A method for selecting an antenna of a diversity antenna system, comprising:
a first signal detecting operation of determining the detection of a signal by comparing whether or not a signal quality value of a signal from a selected antenna is higher than a predetermined first reference value;
a second signal detecting operation of determining whether or not the quality value of the signal is higher than a second reference value set to be lower than the first reference value when the signal is not detected up to a predetermined antenna changing time during the first signal detecting operation;
an antenna changing operation of changing the antenna when the quality value of the signal is lower than the second reference value during the second signal detecting operation;
a change error determining operation of detecting an antenna stay time when the signal is continuously detected and determines whether or not the antenna stay time is within a predetermined error available time when the signal is detected during the first signal detecting operation;
an antenna rechanging operation of changing a current antenna to a previous antenna when the antenna stay time is within the error available time during the change error determining operation; and
a waiting operation of waiting until the antenna stay time exceeds a predetermined no-error time when the antenna stay time is within the error available time during the change error determining operation.

15. The method for selecting an antenna of a diversity antenna system of claim 14, wherein the quality value of the signal is set to be at least one value of a correlation value of the signal, the intensity of the signal, and the power of the signal.

16. The method for selecting an antenna of a diversity antenna system of claim 14, further comprising a signal quality comparing/final antenna selecting operation of, after the antenna rechanging operation or the waiting operation, measuring a signal quality value for the selected antenna, selecting a current antenna as a reception antenna when the measured quality value of the signal is higher than a third reference value set to be higher than the first reference value and selecting a final reception antenna by controlling the change of the antenna and performing the signal quality measurement process again when the measured quality value of the signal is not higher than a third reference value set to be higher than the first reference value.
